(19) United States
(12) Patent Application Publication
(10) Pub. No.: US 2021/0279260 A1
(43) Pub. Date: Sep. 9, 2021

(54) METHOD AND SYSTEM FOR IDENTIFYING AT LEAST ONE COMMUNITY IN A DATASET COMPRISING A PLURALITY OF ELEMENTS

(71) Applicant: 1QB INFORMATION TECHNOLOGIES INC., Vancouver (CA)

(72) Inventors: Jaspreet S. OBEROI, Maple Ridge (CA); Sourav MUKHERJEE, Richmond (CA); Clemens ADOLPHS, Vancouver (CA); Ehsan ZAHEDINEJAD, Richmond (CA); Daniel J. CRAWFORD, Vancouver (CA)

(73) Assignee: 1QB INFORMATION TECHNOLOGIES INC., Vancouver, BC (CA)

(21) Appl. No.: 17/254,661

(22) PCT Filed: Jun. 20, 2019
(86) PCT No.: PCT/IB2019/055226

§ 371 Date: Dec. 21, 2020

Related U.S. Application Data
(60) Provisional application No. 62/688,676, filed on Jun. 22, 2018.

(51) Int. Cl. G06F 16/28; G06N 10/00

(52) U.S. Cl. CPC G06F 16/285; G06F 17/10; G06N 10/00

(57) ABSTRACT

A method and a system are disclosed for identifying at least one community, the method comprising providing an indication of a graph, the graph comprising a plurality of nodes and edges, wherein each node is representative of a given element and each edge is representative of a relationship between two given elements; providing a metric indicative of an underlying community detection algorithm; obtaining an indication of an upper bound value for a given maximum number of communities to identify; encoding each node using a one-hot encoding method and the indication of an upper bound value; generating a quadratic unconstrained binary optimization problem using the metric and the encoded nodes; providing the generated quadratic unconstrained binary optimization problem to an optimization oracle and obtaining a solution.

### CROSS-REFERENCE TO RELATED APPLICATIONS

This application is the U.S. National Stage (371(c)) of International Patent Application No. PCT/IB2019/055266, filed Jun. 20, 2019. Through the '266 Application, this application claims priority to U.S. Provisional Application No. 62/688,676, filed on Jun. 22, 2018.

### FIELD

This Invention pertains to the field of data analysis. More precisely, the Invention relates to a method and a system for identifying at least one community in a dataset comprising a plurality of elements.

### BACKGROUND

Signed graphs (SGs) are ubiquitous in social networks (see Paolo Massa and Paolo Avesani. Controversial users demand local trust metrics: An experimental study on epinions.com community. In Proceedings of the 20th National Conference on Artificial Intelligence—Volume 1, AAAI'05, pages 121-126. AAAI Press, 2005; Jure Leskovec, Daniel Huttenlocher, and Jon Kleinberg. Predicting positive and negative links in online social networks. In Proceedings of the 19th International Conference on World Wide Web, WWW '10, pages 641-650, New York, N.Y., USA, 2010. ACM; and Jérôme Kunegis, Andreas Lommatzsch, and Christian Bauckhage. The slashdot zoo: Mining a social network with negative edges. In Proceedings of the 18th International Conference on World Wide Web, WWW '09, pages 741-750, New York, N.Y., USA, 2009. ACM). They encode the relationship between individuals using signed links between nodes where a positive link between two nodes indicates a positive relationship and a negative link denotes a negative relationship (see Fritz Helder. Attitudes and cognitive organization. The Journal of Psychology, 21(1):107-112, 1946. PMID: 21010780). Thus far, there has been impressive progress toward developing methods to explore different tasks within signed graphs (see Smriti Bhagat, Graham Cormode, and S. Muthukrishnan. Node Classification in Social Networks, pages 115-148. Springer US, Boston, Mass., 2011; David Liben-Nowell and Jon Kleinberg. The link prediction problem for social networks. In Proceedings of the Twelfth International Conference on Information and Knowledge Management, CIKM '03, pages 556-559, New York, N.Y., USA, 2003. ACM; and Charu Aggarwal and Karthik Subbian. Evolutionary network analysis: A survey. ACM Comput. Surv., 47(1):10:1-10:36, May 2014). As the size of social networks grows continually, more effective approaches are required to analyze these networks better.

There exists a range of interesting tasks that can be addressed within the signed graphs domain including link prediction (see David Liben-Nowell and Jon Kleinberg. The link prediction problem for social networks. In Proceedings of the Twelfth International Conference on Information and Knowledge Management, CIKM '03, pages 556-559, New York, N.Y., USA, 2003. ACM; and Kal-Yang Chiang, Nagarajan Natarajan, Ambuj Tewari, and Inderjit S. Dhillon. Exploiting longer cycles for link prediction in signed networks. In Proceedings of the 20th ACM International Conference on Information and Knowledge Management, CIKM '11, pages 1157¬1162, New York, N.Y., USA, 2011. ACM), network evolution (see Charu Aggarwal and Karthik Subbian. Evolutionary network analysis: A survey. ACM Comput. Surv., 47(1):10:1-10:36, May 2014), node classification (see Smriti Bhagat, Graham Cormode, and S. Muthukrishnan. Node Classification in Social Networks, pages 115-148. Springer US, Boston, Mass., 2011) and community detection.

It will be appreciated that the idea behind a community detection task is to divide a signed graph into clusters such that nodes within the same clusters are densely connected by positive links while nodes belonging to different clusters are connected by negative links. FIGS. 6a and 6b show examples of a community detection problem. More precisely, FIG. 6a shows an embodiment of a randomly generated signed graph which illustrates users as a single community while FIG. 6b shows an embodiment of a randomly generated signed graph which illustrates users as a member of one of three communities.

It will be further appreciated that community detection has many applications in various areas including medical science (see Jiancong Chen, Hulling Zhang, Zhi-Hong Guan, and Tao LI. Epidemic spreading on networks with oveulapping community structure. Physica A: Statistical Mechanics and Its Applications, 391(4):1848-1854, 2012; and Marcel Salath and James H. Jones. Dynamics and control of diseases in networks with community structure. PLOS Computational Biology, 6(4):1-11, 042010), telecommunication (see Emilio Ferrara, Pasquale De Meo, Salvatore Catanese, and Giacomo Fiumara. Detecting criminal organizations in mobile phone networks. Expert Systems with Applications, 41(13):5733-5750, 2014), detection of terrorist groups (see Todd Wasklewicz. Friend of a friend Influence in terrorist social networks. In Proceedings on the International Conference on Artificial Intelligence (ICAI), page 1. The Steering Committee of The World Congress in Computer Science, Computer Engineering and Applied Computing (WorddComp), 2012), and information diffusion process (see Shuyang Lin, Qingbo Hu, Guan Wang, and Philip S. Yu. Understand,ing community effects on information diffusion. In Tru Cao, Ee-Peng Lim, Zhi-Hua Zhou, Tu-Bao Ho, David Cheung, and Hiroshi Motoda, editors, Advances in Knowledge Discovery and Data Mining, pages 82-95, Cham, 2015. Springer International Publishing). The vast applicability of community detection methods in different fields of graph networks makes it a very important topic to investigate and devise faster and more effective approaches.

The research work regarding community detection is divided into four general categories (see Jiliang Tang, Yi Chang, Charu Aggarwal, and Huan Liu. A survey of signed network mining in social media. ACM Comput. Surv., 49(3):42:1-42:37, August 2016), i.e., clustering-based, mixture-model-based, dynamic-model-based, and modularity-based.

Over the last decade there has been a large amount of effort to use modularity or a variant of modularity as a means to detect communities in SGs. For Instance, Pranay Anchuri and Malik Magdon-Ismail. Communities and balance in signed networks: A spectral approach. In Proceedings of the 2012 International Conference on Advances in Social Networks Analysis and Mining (ASONAM 2012), ASONAM '12, pages 235-242, Washington, D.C., USA, 2012. IEEE Computer Society, finds the communities by minimizing the frustration or maximizing the modularity as metrics for finding the communities. A. Amello and C. Pizzuti. Community mining in signed networks: A multiobjective approach. In 2013 IEEE/ACM International Conference on Advances in Social Networks Analysis and Mining (ASONAM 2013), pages 95-99, August 2013, proposed a community detection framework called SN-MOGA which uses the non-dominated sorting genetic (see N. Srinivas and K. Deb. Muiltiobjective optimization using non-dominated sorting in genetic algorithms. Evolutionary Computation, 2(3):221-248, September 1994; and C. Pizzuti. A multi-objective genetic algorithm for community detection in networks. In 200921st IEEE International Conference on Tools with Artificial Intelligence, pages 379-386, November 2009) to minimize frustration and maximize signed modularity simultaneously. Authors in Pouya Esmailian, Seyed Ebrahim Abtahi, and Mahdi Jalili. Meso-scopic analysis of online social networks: The role of negative ties. Phys. Rev. E, 90:042817, October 2014, investigate the mesoscopic level of signed graphs by minimization of frustration.

Unfortunately, prior art methods suffer from many drawbacks.

For instance, a first drawback is that the prior art methods do not find the right number of communities per se but can only assign the nodes to the communities when the number of communities is given as an input parameter. A user has to predefine the right number of communities to define, which is definitely cumbersome since the only way to find the right number is to try different number each time and can be very non-intuitive to do in many real-life cases.

A second drawback is that, for cases where more than two communities need to be discovered, current approaches follow a divisive hierarchical clustering, which is, first finding two communities, then dividing them further and so on. This can often lead to localized solutions and introduce artificial local boundaries.

There is a need for at least one of a method and a system that will overcome at least one of the above-identified limitations.

### BRIEF SUMMARY

According to a broad aspect, there is disclosed a computer-implemented method for identifying at least one community in a dataset comprising a plurality of elements, the method comprising providing, using a digital computer, an indication of a graph, the graph comprising a plurality of nodes and edges, wherein each node is representative of a given element and each edge is representative of a relationship between two given elements of the dataset; providing, using the digital computer, a metric indicative of an underlying community detection algorithm; obtaining, using the digital computer, an indication of an upper bound value for a given maximum number of communities to identify in the dataset; encoding, using the digital computer, each node of the graph using a one-hot encoding method and the indication of an upper bound value for the given maximum number of communities to identify in the dataset; generating, using the digital computer, a quadratic unconstrained binary optimization problem using the metric indicative of an underlying community detection algorithm and the encoded nodes of the graph; providing, using the digital computer, the generated quadratic unconstrained binary optimization problem to an optimization oracle; obtaining, using the digital computer, a solution to the generated quadratic unconstrained binary optimization problem from the optimization oracle, the solution being indicative of the identified communities in the dataset and providing, using the digital computer, an indication of the identified communities in the dataset.

In accordance with an embodiment, the metric indicative of an underlying community detection algorithm comprises at least one of a modularity metric or a frustration metric.

According to a broad aspect, there is disclosed a digital computer comprising a central processing unit; a display device; a communication port for operatively connecting the digital computer to an optimization oracle comprising a quantum processor; a memory unit comprising an application for identifying at least one community in a dataset comprising a plurality of elements, the application comprising instructions for providing an indication of a graph, the graph comprising a plurality of nodes and edges, wherein each node is representative of a given element and each edge is representative of a relationship between two given elements of the dataset; instructions for providing a metric indicative of an underlying community detection algorithm; instructions for obtaining an indication of an upper bound value for a given maximum number of communities to identify in the dataset; instructions for encoding each node of the graph using a one-hot encoding method and the indication of an upper bound value for the given maximum number of communities to identify in the dataset; instructions for generating a quadratic unconstrained binary optimization problem using the metric indicative of an underlying community detection algorithm and the encoded nodes of the graph; instructions for providing the generated quadratic unconstrained binary optimization problem to an optimization oracle; instructions for obtaining a solution to the generated quadratic unconstrained binary optimization problem from the optimization oracle, the solution being indicative of the identified communities in the dataset and instructions for providing an indication of the identified communities in the dataset.

According to a broad aspect, there is disclosed a non-transitory computer readable storage medium for storing computer-executable instructions which, when executed, cause a digital computer to perform a method for identifying at least one community in a dataset comprising a plurality of elements, the method comprising providing an indication of a graph, the graph comprising a plurality of nodes and edges, wherein each node is representative of a given element and each edge is representative of a relationship between two given elements of the dataset; providing a metric indicative of an underlying community detection algorithm; obtaining an indication of an upper bound value for a given maximum number of communities to identify in the dataset; encoding each node of the graph using a one-hot encoding method and the indication of an upper bound value for the given maximum number of communities to identify in the dataset generating a quadratic unconstrained binary optimization problem using the metric indicative of an underlying community detection algorithm and the encoded nodes of the graph; providing the generated quadratic unconstrained binary optimization problem to an optimization oracle; obtaining a solution to the generated quadratic unconstrained binary optimization problem from the optimization oracle, the solution being indicative of the identified communities in the dataset and providing an indication of the Identified communities in the dataset.

According to a broad aspect, there is disclosed a method for identifying at least one community in a dataset comprising a plurality of elements, the method comprising providing an indication of a graph, the graph comprising a plurality of nodes and edges, wherein each node is representative of a given element and each edge is representative of a relationship between two given elements of the dataset; providing a metric indicative of an underlying community detection algorithm; obtaining an indication of an upper bound value for a given maximum number of communities to Identify in the dataset; encoding each node of the graph using a one-hot encoding method and the indication of an upper bound value for the given maximum number of communities to Identify in the dataset; generating a quadratic unconstrained binary optimization problem using the metric indicative of an underlying community detection algorithm and the encoded nodes of the graph; providing the generated quadratic unconstrained binary optimization problem to an optimization oracle; obtaining a solution to the generated quadratic unconstrained binary optimization problem from the optimization oracle, the solution being indicative of the identified communities in the dataset and providing an indication of the Identified communities in the dataset.

An advantage of the method disclosed is that it Identifies the communities without a prior knowledge of the number of communities.

Another advantage of the method disclosed is that it determines the right number of communities.

Another advantage of the method disclosed is that the method can be generalized to other community detection metrics which have intrinsic binary polynomial formulation.

Another advantage of the method disclosed is that it improves the processing of a system for identifying at least one community in a dataset comprising a plurality of elements.

### BRIEF DESCRIPTION OF THE DRAWINGS

In order that the invention may be readily understood, embodiments of the invention are illustrated by way of example in the accompanying drawings.

FIG. 1 is a flowchart that shows an embodiment of a method for identifying at least one community in a dataset comprising a plurality of elements. The method comprises, inter alia, a processing step of providing an indication of a graph.

FIG. 2 is a flowchart that shows an embodiment for providing the indication of a graph.

FIG. 3 is a block diagram that shows an embodiment of a system for identifying at least one community in a dataset. The system comprises a digital computer and an optimization oracle.

FIG. 4 is a block diagram that shows an embodiment of a digital computer.

FIG. 5 is a flowchart that shows an embodiment for providing an indication of the identified at least one community.

FIG. 6a shows an embodiment of a randomly generated signed graph which illustrates users as a single community.

FIG. 6b shows an embodiment of a randomly generated signed graph which illustrates users as a member of one of three communities.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain.

The term “i.e.” and like terms mean “that is,” and thus limit the terms or phrases they explain.

The term “optimization oracle” and like terms mean a machine or an algorithm that can produce optimal or near-optimal (i.e., sub-optimal) solutions for optimization problem. In one embodiment, the optimization oracle comprises a quantum annealer. In an alternative embodiment, the optimization oracle is selected from a group consisting of a simulated annealing algorithm, a path integral quantum Monte-Carlo algorithm and a parallel tempering algorithm. In another alternative embodiment, the optimization oracle comprises a digital annealing unit, such as Fujitsu's digital annealer.

The term “quantum annealer” and like terms mean a system consisting of one or many types of hardware that can find optimal or sub-optimal solutions to an unconstrained binary quadratic programming problem. An example of this is a system consisting of a digital computer embedding a binary quadratic programming problem as an Ising spin model, attached to an analog computer that carries optimization of a configuration of spins in an Ising spin model using quantum annealing as described, for example, in Farhi, E. et al., “Quantum Adiabatic Evolution Algorithms versus Simulated Annealing” arXiv.org:quant-ph/0201031 (2002). pp 1-16. An embodiment of such analog computer is disclosed by McGeoch, Catherine C. and Cong Wang, (2013), “Experimental Evaluation of an Adiabiatic Quantum System for Combinatorial Optimization” Computing Frontiers.” May 14-16, 2013 (http-J/www.cs.amherst.edu/ccm/cf14-mcgeoch.pdf) and also disclosed in the patent application US2006/0225165. It will be appreciated that the “quantum annealer” may also interact with a “classical components,” such as a classical computer. Accordingly, a “quantum annealer” may be entirely analog or an analog-classical hybrid.

In the following, G(V, E) denotes a signed graph wherein V is a set of vertices, or nodes, and E⊂V×V denotes a set of edges that are present in the signed graph. v is used to show the number of nodes and e to show the number of edges (links) in the graph. The adjacency matrix of G represented by A where each element of this matrix, Aij takes +1 when there is a positive relation, −1 when there is a negative relation and 0 when there is no relation between the two nodes {i,j}∈V.

Ap is defined as the positive adjacency matrix wherein each element of this matrix Aᵢⱼ^{p}, is equal to the absolute value of the Aᵢⱼ. Given the definition for A and Ap, the elements of positive (P) and negative (N) matrices are defined as follows:

$${P}_{ij} = \frac{{A}_{ij} + {A}_{ij}^{p}}{2} , {N}_{ij} = \frac{{A}_{ij}^{p} - {A}_{ij}}{2} . \qquad ( 1 )$$

The number of non-zero entries in A, P, N are denoted by 2×m, 2×mₚ, 2×mₙ, respectively. The positive degree of vertex I is called pi, and its corresponding negative degree is called ni. The degree of the vertex i is called dᵢ=pᵢ+nᵢ.

A non-empty set of vertex is referred to as [symbol] and it is called a community duster.

The objective of the method is to determine the number k of communities in the dataset of elements and to divide the dataset of elements into the number k of communities [symbol] In one embodiment, it is assumed that each [symbol] (l∈{1, 2, . . . , k}) is a non-empty set of nodes and each node belongs exclusively to one duster, i.e., there is no overlap of nodes between clusters. In an alternative embodiment, at least one community comprises at least one node shared with at least one other community.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a method, a system and non-transitory computer readable storage medium for identifying at least one community in a dataset comprising a plurality of elements.

It will be appreciated that the method may be advantageously used in various applications as disclosed further below.

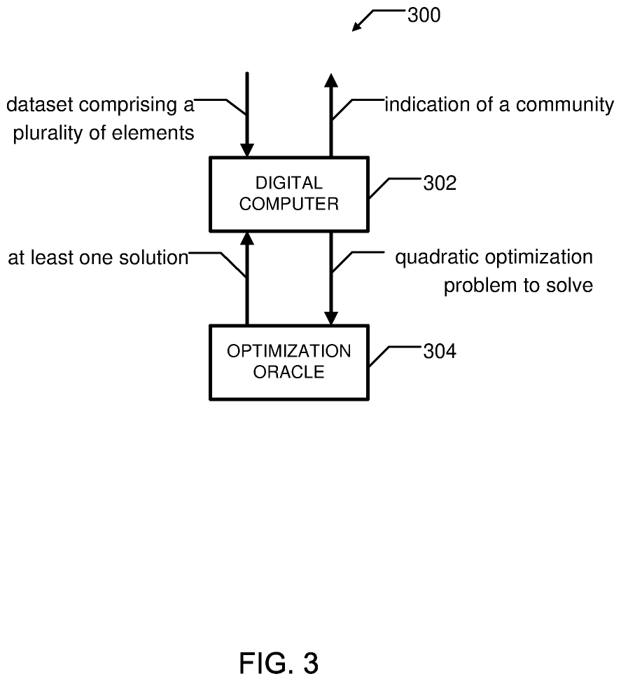

Now referring to FIG. 3, there is shown an embodiment of a system 300 for Identifying at least one community in a dataset comprising a plurality of elements.

The system 300 comprises a digital computer 302 and an optimization oracle 304 operatively connected to the digital computer 302.

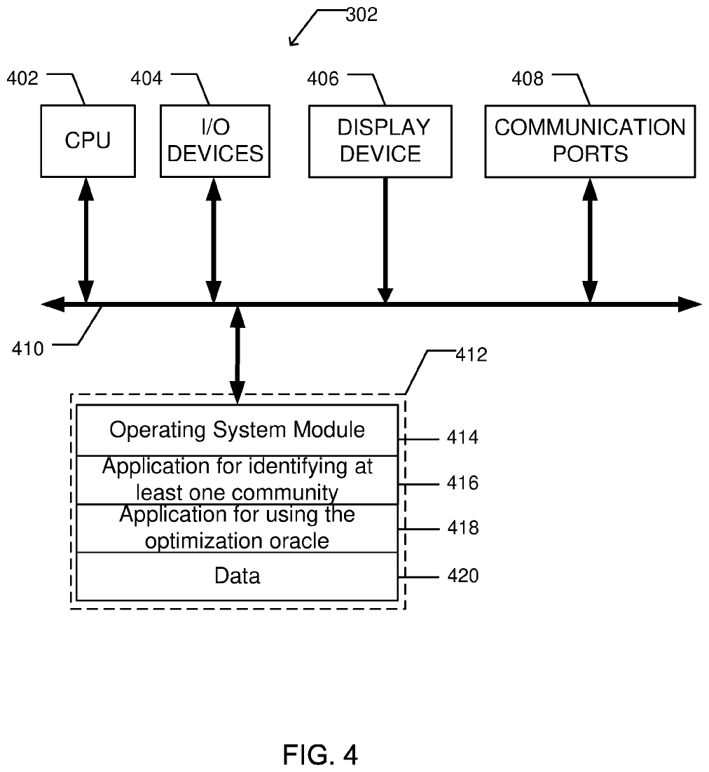

Now referring to FIG. 4, there is shown an embodiment of the digital computer 302. It will be appreciated that the digital computer 302 may be any type of digital computer.

In one embodiment, the digital computer 302 is selected from a group consisting of desktop computers, laptop computers, tablet PC's, servers, smartphones, etc. It will also be appreciated that, in the foregoing, the digital computer 302 may also be broadly referred to as a processor.

In the embodiment shown in FIG. 4, the digital computer 302 comprises a central processing unit 402, also referred to as a microprocessor, Input/output devices 404, a display device 406, communication ports 408, a data bus 410 and a memory unit 412.

The central processing unit 402 is used for processing computer Instructions. The skilled addressee will appreciate that various embodiments of the central processing unit 402 may be provided.

In one embodiment, the central processing unit 402 comprises a CPU Core i53210 running at 2.5 GHz and manufactured by Intel™.

The Input/output devices 404 are used for Inputting/outputting data into the digital computer 400.

The display device 406 is used for displaying data to a user. The skilled addressee will appreciate that various types of display device 406 may be used.

In one embodiment, the display device 406 is a standard liquid crystal display (LCD) monitor.

The communication ports 408 are used for sharing data with the digital computer 302.

The communication ports 408 may comprise, for instance, universal serial bus (USB) ports for connecting a keyboard and a mouse to the digital computer 302.

The communication ports 408 may further comprise a data network communication port, such as an IEEE 802.3 port, for enabling a connection of the digital computer 302 with the optimization oracle 304, an embodiment of which is an analog computer.

The skilled addressee will appreciate that various alternative embodiments of the communication ports 408 may be provided.

The memory unit 412 is used for storing computer-executable instructions.

The memory unit 412 may comprise a system memory such as a high-speed random access memory (RAM) for storing system control program (e.g., BIOS, operating system module, applications, etc.) and a read-only memory (ROM).

It will be appreciated that the memory unit 412 comprises, in one embodiment, an operating system module 414.

It will be appreciated that the operating system module 414 may be of various types.

In one embodiment, the operating system module 414 is OS X Yosemite manufactured by Apple™.

Now referring back to FIG. 3, the digital computer 302 receives a dataset comprising a plurality of elements and provides a quadratic optimization problem to solve to the optimization oracle 304.

The digital computer 302 further receives at least one solution to the quadratic optimization problem to solve from the optimization oracle 304 and provides an indication of at least one community.

The optimization oracle 304 receives a quadratic optimization problem to solve from the digital computer 302 and provide at least one corresponding solution to the digital computer 302.

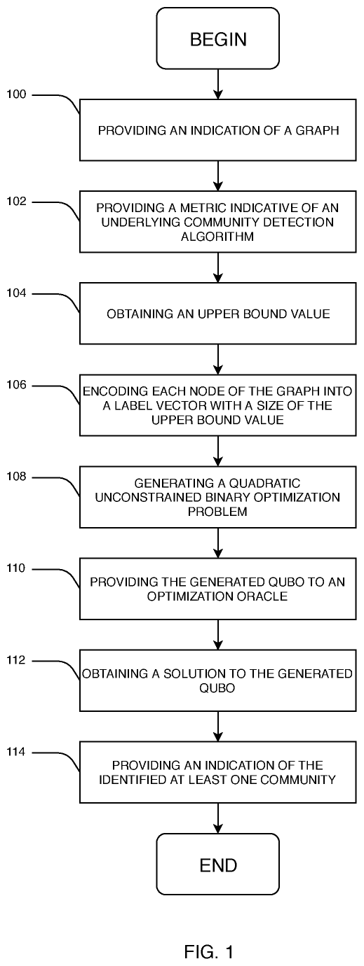

Now referring to FIG. 1, there is shown an embodiment of a method for identifying at least one community in a dataset comprising a plurality of elements.

According to processing step 100, an indication of a graph is provided. It will be appreciated that the graph comprises a plurality of nodes and edges. Each node of the graph is representative of a given element of the dataset comprising a plurality of elements, while each edge is representative of a relationship between two given elements of the dataset. It will be appreciated that the indication of a graph is provided using the digital computer 302.

In fact, it will be appreciated that the indication of a graph may be provided according to various embodiments.

In one embodiment, the indication of a graph is provided by a user interacting with the digital computer 302.

In another embodiment, the indication of a graph is obtained from a remote processing unit operatively coupled to the digital computer 302.

In another embodiment, the indication of a graph is obtained from the memory unit 412 of the digital computer 302.

The skilled addressee will appreciate that various alternative embodiments may be used for providing the indication of a graph.

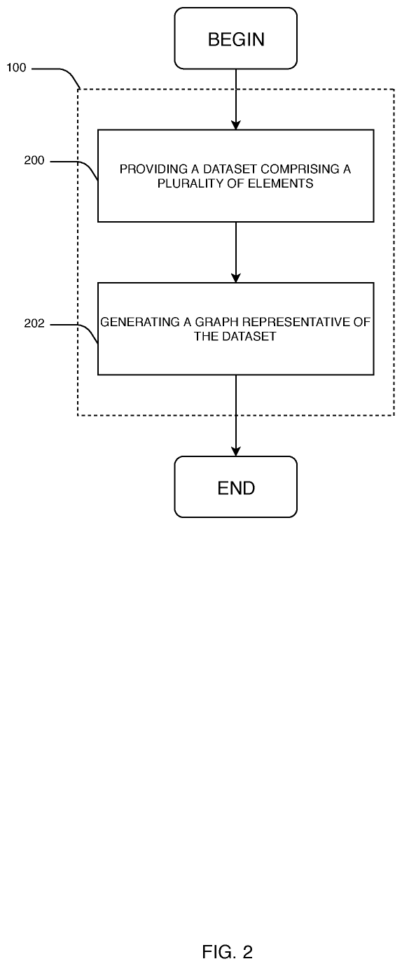

Now referring to FIG. 2, there is shown one embodiment for providing an indication of a graph.

According to processing step 200, a dataset comprising a plurality of elements is provided.

It will be appreciated that the dataset comprising a plurality of elements may be provided according to various embodiments.

In one embodiment, the dataset comprising a plurality of elements is provided by a user interacting with the digital computer 302.

In another embodiment, the dataset comprising a plurality of elements is obtained from a remote processing unit operatively coupled to the digital computer 302.

In another embodiment, the dataset comprising a plurality of elements is obtained from the memory unit 412 of the digital computer 302.

Still referring to FIG. 2 and according to processing step 202, a graph representative of the dataset comprising a plurality of elements is generated.

It will be appreciated that the graph may be generated according to various embodiments.

In one embodiment, the graph is generated by the digital computer 302.

In another embodiment, the graph is generated by a remote processing unit operatively coupled to the digital computer 302.

The skilled addressee will appreciate that various alternative embodiments may be provided for generating the graph.

Now referring back to FIG. 1 and according to processing step 102, a metric indicative of an underlying community detection algorithm is provided.

It will be appreciated that the metric indicative of an underlying community detection algorithm is provided using the digital computer 302.

In fact, it will be appreciated that in the context of communities, a metric is a criterion that can be used to decide and come to a conclusion whether the communities found are worthy or not. It will be appreciated that metrics here are optimization problems, which when solved to optimality, the solution for those can be deciphered as good community detection or good assignment of nodes to the communities.

For example, if the task is to find the best dish out of given 10 dishes, depending on the criteria used the solution to this problem will be different. So a metric can be, vitamin A to the weight ratio, etc.

It will be appreciated that the metrics indicative of a community may be of various types.

In one embodiment, the metric indicative of a community comprises a metric referred to as frustration.

Let us consider a signed graph, G, wherein the goal is to assign a label, sᵢ∈{−1, 1} to each node i∈V, such th the resultant assignment minimizes a notion of frustration and leads into two communities, [symbol] and [symbol] , wherein nodes with the labels −1(+1) belong to the former (latter) communities.

The inter-positive and intra-negative links in [symbol] and [symbol] will increase the frustration, the frustration, [symbol] , can be formulated as follows (see Pranay Anchuri and Malik Magdon-Ismail. Communities and balance in signed networks: A spectral approach. In Proceedings of the 2012 International Conference on Advances in Social Networks Analysis and Mining (ASONAM 2012), ASONAM '12, pages 235-242, Washington, D.C., USA, 2012. IEEE Computer Society):

$$= {A}_{ij} - s Λ {s}^{T} , \qquad ( 2 )$$

wherein s is called the configuration vector which belongs to {−1, 1}^{v}. An optimal solution, e, corresponding to the minimum value of [symbol] will label a node i into either −1 (i.e. node i∈ [symbol] ) or +1 (i.e. node) i∈ [symbol] , hence s* will be the solution to two-community detection problem.

In another embodiment, the metric indicative of a community comprises a metric referred to as modularity.

It will be appreciated that modularity for unsigned networks is defined as a difference between a number of edges falling within the community and a number of edges in an equivalent network when permuted at random (see M. E. J. Newman and M. Girvan. Finding and evaluating community structure in networks. Phys. Rev. E, 69:026113, February 2004).

In other words, it will be appreciated that modularity quantifies a “surprise” measure which explains the statistically surprising configuration of the edges within the community.

It will be appreciated that maximizing modularity is then equivalent to having higher expectation to find edges within communities compared to random chance.

The notion of modularity has been used for detecting communities within unsigned networks (see M. E. J. Newman. Modularity and community structure in networks. Proceedings of the National Academy of Sciences, 103(23):8577, 062006).

It will be appreciated by the skilled addressee that while the following approach is proposed for a signed graph, its generalizing to a general graph, wherein the element of the adjacency matrix is any real number, i.e. Aᵢⱼ∈ [symbol] , is trivial.

For a two-community detection problem, the approach disclosed in M. E. J. Newman. Modularity and community structure in networks. Proceedings of the National Academy of Sciences, 103(23):8577, 062006 may be used and the modularity, [symbol] , up to a constant factor, may be defined as follows:

[symbol]

=sBs^{T} (7)

wherein a real symmetric matrix B has been defined as the modularity matrix with the elements

$${B}_{ij} = {A}_{ij} - \frac{{d}_{i} {d}_{j}}{2 m} . \qquad ( 8 )$$

In equation (8), the term

$$\frac{{d}_{i} {d}_{j}}{2 m}$$

is the expected number of edges between nodes i and j and all the other symbols have their usual meanings.

Given an optimal configuration s* which maximizes equation (7) each node is assigned to one of the two communities [symbol] and [symbol] .

In the case of a signed network, equations (7) and (8) have to be reformulated to include the effect of positive and negative edges.

If it is assumed that the network can be divided into two clusters [symbol] and [symbol] , the equations (7) and (8) can then rewritten into the modularity relation for signed graphs, M_{S} as follows:

$${ℳ}_{S} = {\sum }_{i , j ∈ {C}_{1}} ( {P}_{ij} - \frac{{d}_{pi} {d}_{pj}}{2 {m}_{p}} ) + {\sum }_{i , j ∈ {C}_{2}} ( {P}_{ij} - \frac{{d}_{pi} {d}_{pj}}{2 {m}_{p}} ) + {\sum }_{i ∈ {C}_{1} , j ∈ {C}_{2}} ( {N}_{ij} - \frac{{d}_{ni} {d}_{nj}}{2 {m}_{n}} ) + {\sum }_{i ∈ {C}_{2} , j ∈ {C}_{1}} ( {N}_{ij} - \frac{{d}_{ni} {d}_{nj}}{2 {m}_{n}} ) . \qquad ( 9 )$$

Focusing on the right hand side of equation (9), the first two terms are merged into a sum over all nodes by multiplying each of the terms by:

$$\frac{1}{2} ( 1 + {s}_{i} {s}_{j} ) \qquad ( 10 )$$

and the last two terms are merged by multiplying each term by:

$$\frac{1}{2} ( 1 - {s}_{i} {s}_{j} ) . \qquad ( 11 )$$

Equation (9) can be written in a matrix form as:

[symbol]

_{S}=sB_{S}s^{T}, (12)

wherein Bs is called the singed modularity matrix in which for any two given nodes {i,j}∈V each of its element, B_{S}_{ᵢⱼ}, is defined as:

$${B}_{{S}_{ij}} = {A}_{ij} + \frac{{d}_{{n}_{i}} {d}_{{n}_{j}}}{2 {m}_{n}} - \frac{{d}_{{p}_{i}} {d}_{{p}_{j}}}{2 {m}_{p}} . \qquad ( 13 )$$

All symbols in (9) and (12-13) have their usual meanings. Given an optimal configuration s which maximizes (12), each node will be assigned to one of the two communities [symbol] and [symbol] .

According to processing step 104, an upper bound value for a given maximum number of communities to identify in the dataset is obtained.

It will be appreciated that the upper bound value for a given maximum number of communities to identify in the dataset is obtained using the digital computer 302.

It will be appreciated that the upper bound value for a given maximum number of communities to Identify in the dataset may be obtained according to various embodiments.

In one embodiment, the upper bound value for a given maximum number of communities is obtained from a user interacting with the digital computer 302.

In another alternative embodiment, the upper bound value for a given maximum number of communities is obtained from the memory unit 412 of the digital computer 302.

In another alternative embodiment, the upper bound value for a given maximum number of communities is obtained from a remote processing unit operatively coupled to the digital computer 302.

According to processing step 106, each node i of the graph G is encoded using a one-hot encoding method and the indication of an upper bound value for the given maximum number of communities to Identify in the dataset. It will be appreciated that this processing step is performed using the digital computer 302.

In fact, it will be appreciated that a one-hot encoding method is used to encode each node, i, into a label vector with a size of the provided upper bound value, k. It will be appreciated that the number of communities detected in the end is smaller or equal to the upper bound value, k. In particular S, is defined as:

sᵢ=[sᵢ₁,sᵢ₁, . . . ,sᵢₖ] (3)

wherein s_{ic}(c∈{1, 2, . . . , k}) is 1 if node i belongs to c^{th} cluster and 0 otherwise. In this case, non-overlapping clusters are considered, then each node will only be assigned to only one cluster, therefore the following constraint exists over the label of node is:

∥sᵢ∥=1, (4)

wherein ∥⋅∥ is l₁-norm operator. From (3) and (4) it is possible to derive that if the two nodes i, j belong to the same community:

sᵢsⱼ^{T}=1, (5)

and zero otherwise.

It will be appreciated that the method disclosed herein may be used to find communities with “shared nodes,” meaning communities with fuzzy boundaries. In such case, the one-hot encoding processing step is different since there are at least one overlapping cluster.

According to processing step 108, a quadratic unconstrained binary optimization problem is generated using the metric indicative of an underlying community detection algorithm and the encoded nodes of the graph. It will be appreciated that the quadratic unconstrained binary optimization problem is generated using the digital computer 302.

In the case wherein the community metric is frustration, and given equations (3-5), the two-community frustration function (2) can be advantageously generalized into the k-community frustration measure, [symbol] ,

$$= ( {A}_{ij} - {A}_{ij} {s}_{i} {s}_{j}^{T} ) + M {\sum }_{i} {( 1 - ‖ {s}_{i} ‖ )}^{2} . \qquad ( 6 )$$

It will be appreciated by the skilled addressee that, in equation (6), the non-overlapping condition is enforced by adding the second term on the right-hand side as a penalty term to the objective function in which M is a large positive real number as the penalty coefficient. The first term on the right-hand side of equation (6) guarantees the frustration constraint, i.e., assigning nodes to each cluster such that to minimize the number of negative edges within communities as well as number of positive links between communities.

It will be further appreciated that in equation (6), the k-community detection problem has been advantageously transformed into a quadratic unconstrained binary optimization problem.

It will be appreciated that minimizing [symbol] with respect to each sᵢ will lead to a optimal solution sᵢ which assigns the node i into a specific cluster.

In the case wherein the community metric comprises a modularity metric, and given the one-hot encoding approach in equation (3) and the two constraints (5) and (4), (12) can be advantageously rewritten for the modularity of k-community detection, [symbol] _{S}^{k}, as follows:

$${ℳ}_{S}^{k} = {B}_{{S}_{ij}} {s}_{i} {s}_{j}^{T} - M {\sum }_{i} {( 1 - ‖ {s}_{i} ‖ )}^{2} \qquad ( 14 )$$

where B_{S}_{ᵢⱼ} is defined in (13).

It will be appreciated that in (14), the k-community detection problem has been transformed into a quadratic unconstrained binary optimization problem.

It will be appreciated by the skilled addressee that maximizing MS with respect to each si will lead to an optimal solution si* which assigns a node i into a specific cluster.

According to processing step 110, the generated quadratic unconstrained binary optimization problem is provided to an optimization oracle 304.

It will be appreciated that the generated quadratic unconstrained binary optimization problem may be provided to the optimization oracle 304 according to various embodiments.

In one embodiment, the generated quadratic unconstrained binary optimization problem is provided by the digital computer 302 to the optimization oracle 304 via the communication ports 408 of the digital computer 302.

According to processing step 112, a solution to the generated quadratic unconstrained binary optimization problem is obtained from the optimization oracle. The solution obtained is indicative of the Identified communities in the dataset comprising a plurality of elements. It will be appreciated that the solution to the generated quadratic unconstrained binary optimization problem is obtained from the optimization oracle using the digital computer 302.

It will be appreciated that the solution to the generated quadratic unconstrained binary optimization problem may be obtained from the optimization oracle 304 according to various embodiments.

In one embodiment, the solution to the generated quadratic unconstrained binary optimization problem is obtained from the optimization oracle 304 via the communication ports 408 of the digital computer 302.

According to processing step 114, an indication of the identified at least one community is provided.

It will be appreciated that the indication of the identified at least one community may be provided according to various embodiment.

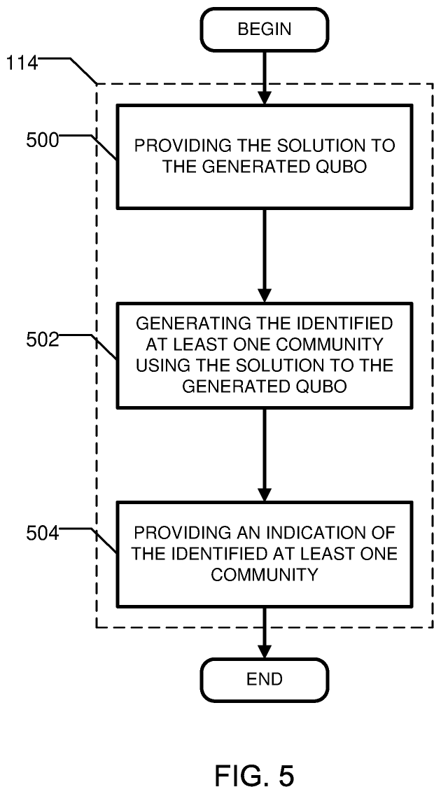

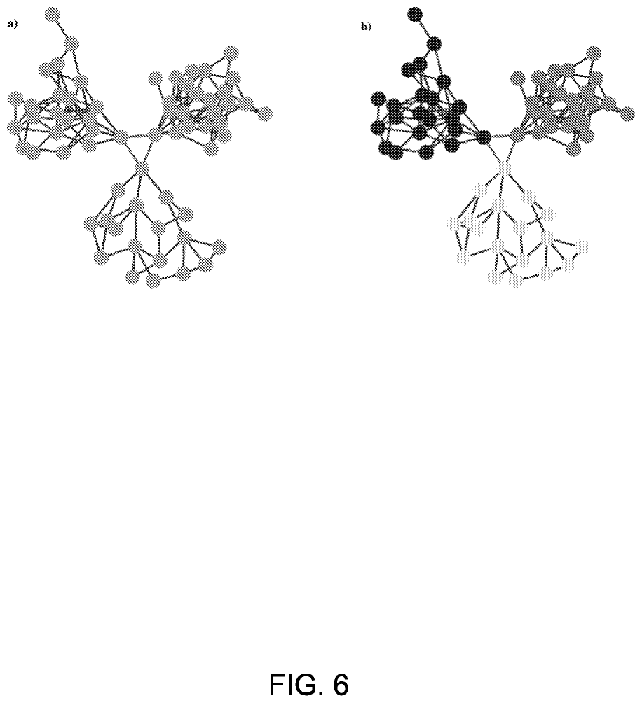

Now referring to FIG. 5, there is shown an embodiment for providing an indication of the Identified at least one community.

According to processing step 500, the solution to the generated quadratic unconstrained binary optimization problem is provided.

According to processing step 502, the identified at least one community is generated using the solution to the generated quadratic unconstrained binary optimization problem.

According to processing step 504, an indication of the identified at least one community is provided. It will be appreciated that the Indication of the Identified at least one community is provided using the digital computer 302.

In one embodiment, the indication of the identified at least one community is provided to the user interacting with the digital computer 302 using for instance the display device 406 of the digital computer 302.

In one embodiment, the indication of the identified at least one community is stored in the memory unit 412 of the digital computer 302.

In another embodiment, the indication of the identified at least one community is provided to a remote processing unit operatively coupled to the digital computer 302.

Now referring back to FIG. 4, it will be appreciated that the memory unit 412 further comprises an application for identifying at least one community in a dataset comprising a plurality of elements 416. The application 416 comprises instructions for providing an indication of a graph, the graph comprising a plurality of nodes and edges, wherein each node is representative of a given element and each edge is representative of a relationship between two given elements of the dataset. The application 416 further comprises instructions for providing a metric indicative of an underlying community detection algorithm. The application 416 further comprises instructions for obtaining an indication of an upper bound value for a given maximum number of communities to identify in the dataset. The application 416 further comprises instructions for labelling each node of the graph using a one-hot encoding method and the indication of an upper bound value for the given maximum number of communities to identify in the dataset. The application 416 further comprises instructions for generating a quadratic unconstrained binary optimization problem using the metric indicative of an underlying community detection algorithm and the labelled nodes of the graph. The application 416 further comprises instructions for providing the generated quadratic unconstrained binary optimization problem to the optimization oracle 304. The application 416 further comprises instructions for obtaining a solution to the generated quadratic unconstrained binary optimization problem from the optimization oracle 304, the solution being indicative of the identified communities in the dataset. The application 416 further comprises instructions for providing an indication of the identified communities in the dataset.

The memory unit 112 may further comprise an application for using the optimization oracle 418.

The memory unit 112 may further comprise data 420 which may be used by at least one of the operating system module 414, the application for identifying at least one community 416 and the application for using the optimization oracle 418.

It will be appreciated that the method disclosed herein enables the problem of multi-community detection in a dataset comprising a plurality of elements to be solved. As disclosed above, the multi-community detection problem is advantageously formulated as a quadratic unconstrained binary optimization (QUBO) problem. The optimal solution of the quadratic unconstrained binary optimization (QUBO) problem corresponds to the solution of multi-community detection problem. Having the underlying problem as a quadratic unconstrained binary optimization (QUBO) problem, the method disclosed herein advantageously benefits from an approximate, heuristic or quantum quadratic unconstrained binary optimization (QUBO) problem solvers.

It will be appreciated that the method for identifying at least one community in a dataset comprising a plurality of elements may be used in many applications.

For instance, an application may be for community detection in network medicine. Biological networks and processes are governed by complex inter- and intra-cellular communication through molecular interactions mediated by many different types of molecules (nodes) including, but not limited to nucleic acids, genes, DNA. RNA, proteins, lipids, glycans, receptors, ligands, hormones, neurotransmitters, nucleic acid modifications, post-translational modifications, regulatory elements, metabolites, and therapeutics. It should be noted that network elements can be from both host and foreign sources. Biological networks and processes can be represented as graphs which are signed or unsigned, weighted or un weighted, unidirectional or bidirectional, etc., and can be clustered into nodes comprised of components with defined relationships thus enabling linkage prediction and interaction analysis relevant for a variety of life sciences, biotechnology, biopharma, and healthcare applications. Changes in Interaction networks may be due to many factors including normal biological processes e.g.: development changes, etc., disease states, e.g.: genetic mutations, cancer, etc., and/or external environmental elements, such as toxins, infectious agents, etc. Regardless of the cause of the network changes, both nodes and edges can be altered in a variety of ways including, but not limited to, interaction density (i.e. number of nodes and edges, edge weight, sign, directionality, etc.), node size, node type, and node boundary thereby resulting in both local and global interaction network alterations. Thus, the detection of changes in communities in a network may be critical for identification of genes and pathways related to the cause (developmental, disease, infection, etc) and identification of opportunities for drug targeting, identification of biomarkers, and improved disease classification to name a few. It will be therefore appreciated that the invention may be advantageously used to identify communities within a normal biological network and when compared to altered networks may facilitate the aforementioned applications, particularly in the context of the human interactome and is equally applicable for all organisms. This is particularly useful as fuzzy community boundaries are currently difficult to identify and frequently arbitrarily defined with limited to no biological context. Furthermore, since the number of communities is determined by community relationships as a function of the method disclosed above as opposed to being arbitrarily defined, the identified communities are based on relevant biological context. Thus, the method disclosed herein advantageously provides biologically relevant community detection for network medicine applications.

It will be appreciated that a non-transitory computer readable storage medium is disclosed for storing computer-executable instructions which, when executed, cause a digital computer to perform a method for for Identifying at least one community in a dataset comprising a plurality of elements. The method comprises providing an indication of a graph, the graph comprising a plurality of nodes and edges, wherein each node is representative of a given element and each edge is representative of a relationship between two given elements of the dataset; providing a metric indicative of an underlying community detection algorithm; obtaining an indication of an upper bound value for a given maximum number of communities to Identify in the dataset; encoding each node of the graph using a one-hot encoding method and the indication of an upper bound value for the given maximum number of communities to identify in the dataset; generating a quadratic unconstrained binary optimization problem using the metric indicative of an underlying community detection algorithm and the encoded nodes of the graph; providing the generated quadratic unconstrained binary optimization problem to an optimization oracle; obtaining a solution to the generated quadratic unconstrained binary optimization problem from the optimization oracle, the solution being indicative of the identified communities in the dataset and providing an indication of the identified communities in the dataset.

It will be appreciated that the method disclosed herein is of great advantage for various reasons.

In fact, an advantage of the method disclosed is that it identifies the communities without a prior knowledge of the number of communities.

Another advantage of the method disclosed is that it determines the right number of communities.

Another advantage of the method disclosed is that the method can be generalized to other community detection metrics which have intrinsic binary polynomial formulation.

Another advantage of the method disclosed is that it Improves the processing of a system for identifying at least one community in a dataset comprising a plurality of elements.

1. A method for identifying at least one community in a dataset comprising a plurality of elements, the method comprising:
providing, using a digital computer, an indication of a graph, the graph comprising a plurality of nodes and edges, wherein each node is representative of a given element and each edge is representative of a relationship between two given elements of the dataset:
providing, using the digital computer, a metric indicative of an underlying community detection algorithm;
obtaining, using the digital computer, an indication of an upper bound value for a given maximum number of communities to identify in the dataset;
encoding, using the digital computer, each node of the graph using a one-hot encoding method and the indication of an upper bound value for the given maximum number of communities to identify in the dataset;
generating, using the digital computer, a quadratic unconstrained binary optimization problem using the metric indicative of an underlying community detection algorithm and the encoded nodes of the graph;
providing, using the digital computer, the generated quadratic unconstrained binary optimization problem to an optimization oracle;
obtaining, using the digital computer, a solution to the generated quadratic unconstrained binary optimization problem from the optimization oracle, the solution being indicative of the identified communities in the dataset; and
providing, using the digital computer, an indication of the identified communities in the dataset.

2. The method as claimed in claim 1, wherein the providing of the indication of a graph comprises at least one of obtaining the indication of a graph from a remote processing unit operatively coupled to the digital computer, obtaining the indication of a graph from a memory unit of the digital computer and obtaining the indication of a graph from a user interacting with the digital computer.

3. The method as claimed in claim 1, wherein the providing of the indication of a graph comprises providing a dataset comprising a plurality of elements and generating a graph representative of the dataset.

4. The method as claimed in claim 1, wherein the providing of the indication of the identified communities in the dataset comprises at least one of providing the indication of the identified communities to a remote processing unit operatively coupled with the digital computer, saving the indication of the identified communities in a memory unit of the digital computer and displaying the indication of the identified communities to a user interacting with the digital computer.

5. The method as claimed in claim 1, wherein the metric indicative of an underlying community detection algorithm comprises at least one of a modularity metric and a frustration metric.

6. A digital computer comprising:
a central processing unit;
a display device;
a communication port for operatively connecting the digital computer to an optimization oracle comprising a quantum processor;
a memory unit comprising an application for identifying at least one community in a dataset comprising a plurality of elements, the application comprising:
instructions for providing an indication of a graph, the graph comprising a plurality of nodes and edges, wherein each node is representative of a given element and each edge is representative of a relationship between two given elements of the dataset;
instructions for providing a metric indicative of an underlying community detection algorithm;
instructions for obtaining an indication of an upper bound value for a given maximum number of communities to identify in the dataset;
instructions for encoding each node of the graph using a one-hot encoding method and the indication of an upper bound value for the given maximum number of communities to identify in the dataset;
instructions for generating a quadratic unconstrained binary optimization problem using the metric indicative of an underlying community detection algorithm and the encoded nodes of the graph;
instructions for providing the generated quadratic unconstrained binary optimization problem to an optimization oracle;
instructions for obtaining a solution to the generated quadratic unconstrained binary optimization problem from the optimization oracle, the solution being indicative of the identified communities in the dataset; and
instructions for providing an indication of the identified communities in the dataset.

7. A non-transitory computer readable storage medium for storing computer-executable instructions which, when executed, cause a digital computer to perform a method for identifying at least one community in a dataset comprising a plurality of elements, the method comprising:
providing an indication of a graph, the graph comprising a plurality of nodes and edges, wherein each node is representative of a given element and each edge is representative of a relationship between two given elements of the dataset;
providing a metric indicative of an underlying community detection algorithm;
obtaining an indication of an upper bound value for a given maximum number of communities to identify in the dataset;
encoding each node of the graph using a one-hot encoding method and the indication of an upper bound value for the given maximum number of communities to identify in the dataset;
generating a quadratic unconstrained binary optimization problem using the metric indicative of an underlying community detection algorithm and the encoded nodes of the graph;
providing the generated quadratic unconstrained binary optimization problem to an optimization oracle;
obtaining a solution to the generated quadratic unconstrained binary optimization problem from the optimization oracle, the solution being indicative of the identified communities in the dataset; and
providing an indication of the identified communities in the dataset.

8. A method for identifying at least one community in a dataset comprising a plurality of elements, the method comprising:
providing an indication of a graph, the graph comprising a plurality of nodes and edges, wherein each node is representative of a given element and each edge is representative of a relationship between two given elements of the dataset;
providing a metric indicative of an underlying community detection algorithm;
obtaining an indication of an upper bound value for a given maximum number of communities to identify in the dataset;
encoding each node of the graph using a one-hot encoding method and the indication of an upper bound value for the given maximum number of communities to identify in the dataset;
generating a quadratic unconstrained binary optimization problem using the metric indicative of an underlying community detection algorithm and the encoded nodes of the graph;
providing the generated quadratic unconstrained binary optimization problem to an optimization oracle;
solving the generated quadratic unconstrained binary optimization problem using the optimization oracle to provide a solution to the generated quadratic unconstrained binary optimization problem, the solution being indicative of the identified communities in the dataset; and
providing an indication of the identified communities in the dataset.

9. The method as claimed in claim 1, wherein the graph is one of a signed graph and a general graph.

10. The digital computer comprising the application as claimed in claim 6, wherein the graph is one of a signed graph and a general graph.

11. The non-transitory computer readable storage medium for storing computer-executable instructions as claimed in claim 7, wherein the graph is one of a signed graph and a general graph.

12. The method as claimed in claim 1, wherein the optimization oracle comprises a quantum annealer.
